(19) United States
(12) Patent Application Publication
(10) Pub. No.: US 2020/0381834 A1
(43) Pub. Date: Dec. 3, 2020

(54) Antennas and Related Methods for Realizing Endfire Radiation with Vertical Polarization

(71) Applicant: The Regents of the University of California, Oakland, CA (US)

(72) Inventors: Haozhan Tian, Los Angeles, CA (US); Lijun Jiang, Hong Kong (HK); Tatsuo Itoh, Los Angeles, CA (US)

(73) Assignee: The Regents of the University of California, Oakland, CA (US)

(21) Appl. No.: 16/889,064

(22) Filed: Jun. 1, 2020

Related U.S. Application Data
(60) Provisional application No. 62/858,914, filed on Jun. 7, 2019.
(60) Provisional application No. 62/855,790, filed on May 31, 2019.

(51) Int. Cl. H01Q 9/18; H01Q 13/18

(52) U.S. Cl. CPC H01Q 9/18; H01Q 13/18

(57) ABSTRACT

Apparatus and systems for antennas for endfire radiation with vertical polarization are described. In an embodiment, an antenna includes a top patch, a ground substrate defining a hole, a feeding cable disposed to mate with the hole, two coupled radiating resonant cavities having two eigen-modes, where the coupled radiating resonant cavities are configured to form a beam, and where the antenna is configured for endfire radiation with vertical polarization.

### CROSS-REFERENCE TO RELATED APPLICATIONS

The current application claims priority to U.S. Provisional Patent Application No. 62/855,790, entitled “Antennas and Related Methods for Realizing Endfire Radiation with Vertical Polarization” filed May 31, 2019 and U.S. Provisional Patent Application No. 62/858,914, entitled “Antennas and Related Methods for Realizing Endfire Radiation with Vertical Polarization” filed Jun. 7, 2019. The disclosures of U.S. Provisional Patent Application No. 62/855,790 and U.S. Provisional Patent Application No. 62/858,914 are incorporated by reference herein in their entireties.

### FIELD OF THE INVENTION

The present invention generally relates to antennas and, more specifically, to antennas for endfire radiation with vertical polarization.

### BACKGROUND

Endfire antennas with polarization perpendicular to the ground, also known as vertical polarization, are desired in many modern communications. The endfire pattern offers strong radiations on the horizontal plane, which is preferred for the communications between systems on a horizontal platform, like ground-wave or vehicle-to-vehicle communication. In the meantime, the wave with vertical polarization, compared to that with horizontal polarization, suffers less attenuation and less disruption on the polarization during propagating along the ground. The traditional antennas for this application, however, suffer from either bulky and complex structures, or squint beams which leads to a waste of energy.

### BRIEF SUMMARY OF THE INVENTION

Apparatus and systems in accordance with various embodiments of the invention enable the design and/or implementation of antennas for endfire radiation with vertical polarization. In an embodiment, an antenna includes: a top patch, a ground substrate defining a hole, a feeding cable disposed to mate with the hole, two coupled radiating resonant cavities having two eigen-modes, where the coupled radiating resonant cavities are configured to form a beam, where the antenna is configured for endfire radiation with vertical polarization

In a further embodiment, the feeding cable is wrapped with an absorber.

In a further embodiment again, the antenna further includes a balun configured as a common mode choke on the feeding cable.

In still a further embodiment, the balun is a quarter wavelength sleeve balun as the common mode choke outside the feeding cable.

In still a further embodiment again, a length of the antenna is approximately a quarter wavelength in free space to enable endfire patterns.

In yet a further embodiment, the feeding cable provides a phase shift to the edge fields at one side to make the beam of the antenna pointing to the forward endfire at both even and odd mode.

In a further embodiment still, the ground substrate is the same size as a top patch to avoid diffraction of the ground edges.

The antenna of claim 1, wherein the ground substrate has a dielectric constant of 3.66 so that the length of the antenna is approximately equal to a quarter wavelength in free space.

In still a further embodiment again, the antenna further includes several metal vias arranged in a line connecting the top patch to the ground substrate and are positioned at the center.

In still a further embodiment again, the antenna further includes a gap, where the several metal vias are placed in a line from one side to the other side of the antenna and the gap is an enlarged spacing omitting vias in the center of the line.

In still a further embodiment again still, the gap is about 5 millimeters.

In still a further embodiment again, the metal vias have a spacing of about 3.2 millimeters.

In still a further embodiment again, the metal vias have a diameter of about 1.6 millimeters.

In still a further embodiment again, the antenna works in coupled modes.

In still a further embodiment again, the coupling is either even mode or odd mode.

In still a further embodiment again, the ground substrate is of a dielectric material.

In still a further embodiment again, the top patch is of a conductive material.

In still a further embodiment again, the feeding cable is back-fed to the antenna.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a schematic of an antenna in accordance with an embodiment of the invention.

FIG. 2 shows the E field vector distribution in the coupled cavity for even mode and odd mode of an antenna in accordance with an embodiment of the invention.

FIG. 3 shows patterns of even and odd modes calculated by the array factor of two elements with an additional phase delay in accordance with an embodiment of the invention.

FIG. 4 shows simulated frequency responses of the antenna with different excitation locations in accordance with an embodiment of the invention.

FIG. 5 shows simulated radiation patterns of the antenna with different excitation locations at even-mode pole on xz plane of cut in accordance with an embodiment of the invention.

FIG. 6 conceptually illustrates simulated radiation patterns on E-plane of an antenna at even mode with different ground length I_{g}=Iₜ; 4Iₜ; inf (infinite ground) in accordance with an embodiment of the invention.

FIG. 7 conceptually illustrates an equivalent circuit model of an antenna in accordance with an embodiment of the invention.

FIG. 8 shows simulated co-polarized patterns on Elevation plane (E plane, xz plane) and Azimuth plane (xy plane) of an antenna in accordance with an embodiment of the invention.

FIG. 9 shows a fabricated sample fed via a quarter-wavelength sleeve (bazooka) balun in accordance with an embodiment of the invention.

FIG. 10 shows the simulated and measured S₁₁ responses for an antenna with and without a balun in accordance with an embodiment of the invention.

FIG. 11 shows the simulated and measured patterns of an antenna fed via balun in accordance with an embodiment of the invention.

FIG. 12 shows the forward endfire realized gain and F/B ratio of an antenna in accordance with an embodiment of the invention.

FIG. 13 shows the measured and simulated total efficiencies of an antenna design in accordance with an embodiment of the invention.

### DETAILED DESCRIPTION

Antennas for endfire radiation with vertical polarization can be realized in accordance with various embodiments of the invention. Many embodiments of the invention include methods for realizing such implementations on low-profile and compact resonant antennas. Such antennas can be implemented in a variety of applications, including but not limited to chip-to-chip, vehicle-to-vehicle, other on-ground communications, and any other communication systems on a horizontal platform. In some embodiments, methods for realizing such antennas are based on constructing coupled modes between two or more radiating resonators. By way of example, the discussions below and in later sections apply the methods to a patch antenna. However, methods in accordance with various embodiments of the invention can be applied not only to different shapes of patch antennas, but also to other on-board (on-chip) resonant antennas, such as but not limited to half-mode substrate integrated waveguide antennas.

Antennas in accordance with various embodiments of the invention can offer endfire radiation with vertical polarization in a very compact and low-profile structure. Although small in size, the antennas can offer decent endfire gain with vertical polarization. Additionally, such antennas have advantages in the simplicity of their configuration, inexpensive fabrication, and high selectivity. In a number of embodiments, the antenna has high selective two-pole S₁₁ response with center frequency of around 2.41 GHz and 10-dB fractional bandwidth of about 2.0%. In many embodiments, the antennas are easy to scale to different frequency domains. In some embodiments, the antennas can be integrated with on-chip or on-board designs. In a number of embodiments, the antenna can have a high selective response that can prevent it from undesired off-band crosstalk, thus offering better isolation, which can be very useful in some applications. Like patch antenna, the maximum realized gain along with the bandwidth and F/B ratio of the antenna could be further improved by increasing the width or height of the design as long as the two coupled modes are not destroyed. Phased array concept can be implemented on top of the design to achieve scanning performance.

In endfire coupled-mode patch antennas in accordance with various embodiments of the invention, the basic idea is to manipulate the phase at the two radiating slots. Besides the phase controlled by even and odd mode, additional phase delay can be introduced by the feeding structure to ensure forward endfire radiation for both modes. In this way, the beam can point to the forward endfire direction within the whole band. The ground of the antenna can be truncated to be the same or approximately the same size of the top patch, which can reduce or eliminate the undesired effect of the ground edge and ensure the symmetric patterns along horizontal plane. In many embodiments, the overall size of the antenna is approximately 0.26λ₀ by 0.44λ₀, where λ₀ is the free-space wavelength at the center operating frequency. Simulated patterns indicate the endfire radiations within the band despite the slight pattern changing with frequency. However, the common mode current on the outside of a feeding coaxial cable can radiate and perturb the measured patterns as well as the realized endfire gain and total efficiency. In some embodiments, the antenna is fed via a quarter-wavelength bazooka balun, which serves as a common mode current choke and blocks the current carried on the outside of the coaxial cable, avoiding energy waste and undesired radiations. In some embodiments, the measured 3-dB bandwidth of realized gain at forward endfire is about 2.5% with a maximum of about 2.8 dBi at center frequency of about 2.41 GHz. At the same frequency, the measured front-to-back (F/B) ratio has a maximum value of about 17.1 dB. The maximum total efficiency is about 67.8% measured at about 2.43 GHz. As can readily be appreciated, the specific configuration and construction of the antenna can vary and depend on the specific requirements of a given application. Endfire antennas and the design and operation of such antennas in accordance with various embodiments of the invention are discussed below in further detail.

I. Endfire Antennas

Endfire antennas with polarization perpendicular to the ground, also known as vertical polarization, are desired in many modern communications. The endfire pattern offers strong radiations on the horizontal plane, which is preferred for the communications between systems on a horizontal platform, such as but not limited to ground-wave and vehicle-to-vehicle communication. Additionally, waves with vertical polarization, compared to that with horizontal polarization, suffer less attenuation and less disruption on the polarization during propagation along the ground. Traditional Yagi-Uda antennas assembled to be perpendicular to the ground, as an example, have been widely used due to its high directivity. Such antennas are typically implemented by a set of metal wires as an array of electric dipoles. It, thus, suffers from heavy and bulky structure.

Planar microstrip Yagi array antennas, which integrate the Yagi arrays onto low profile substrate by using microstrip-type radiators, have been reported. These antennas offer numerous advantages over the prior antennas, including having a low profile, ease-of-fabrication, and high directivity. However, the radiations of such designs are either horizontally polarized, or are pointed away from endfire direction, which waste more input energy to maintain the same endfire communication. In addition to Yagi-Uda antennas, dominant mode leaky-wave antennas have been claimed to have the capability of endfire radiation through the control of the propagation constant of the leaky wave. However, its peak gain is away from endfire direction.

Besides the Yagi antennas, low-profile Vivaldi antennas, or tapered slot antennas, are capable of radiating endfire beams. This type of antenna applies a tapered slot, which is typically integrated onto a thin substrate, to radiate energy out. The biggest advantage of Vivaldi antennas is their broadband response, which makes them very useful for ultrawide-band (UWB) applications. Due to the radiation mechanism, those antennas are fundamentally limited to horizontal polarization.

Recently, a new beam-scanning antenna, coupled-mode patch antenna (CMPA), has been reported. Such antennas are capable of reforming their beams by manipulating the phase of the fringing fields at the edges. The antennas share similar configuration to a regular patch antenna, but include metal via posts around the center, which introduce coupled modes into the cavity. The coupled modes enable phase changing with frequency at the two radiating slots. The antenna, then, behaves like an array of two radiating elements with controllable phases, which allows for scanning of the beam as a function of frequency. The design benefits from its simplicity, compact size, and low cost. More importantly, the idea of manipulating the phases in a single-element antenna opens the gate to realize many other applications. Coupled-mode patch antennas are discussed in further detail in U.S. Provisional Patent Application No. 62/822,421, filed Mar. 22, 2019 and entitled “Beam Controllable Patch Antenna,” and U.S. Provisional Patent Application No. 62/827,511, filed Apr. 1, 2019 and entitled “Systems and Methods for Single-Element Fixed-Frequency Beam Steering Antennas.” The disclosures of U.S. Provisional Patent Application Nos. 62/822,421 and 62/827,511 are hereby incorporated by reference in their entireties for all purposes.

The concept of CMPA can be implemented to realize endfire radiation with vertical polarization in accordance with various embodiments of the invention. In some embodiments, the length of the proposed antenna is designed to be around quarter wavelength, which enables its endfire patterns. The coupling modes can be excited inside the cavity, similar to CMPA. The etched-out hole on the ground, left for the back-fed coaxial probe, can bring additional phase delay to the edge fields at one side. Due to this additional delay, the beam of this antenna points to the forward endfire, θ=90°, at both even and odd mode. The ground can be designed to be the same size as the top patch, which further reduces the antenna size and avoid undesired diffractions of the ground edges. In this way, the radiation of the antenna points to endfire exactly, or approximately, which can be proven by simulated results. During the measurement, however, the antenna, like dipole antenna, can suffer from the unbalanced current, also known as common mode current carried on the outside of the feeding coaxial cable. The undesired current radiates and perturbs the antenna patterns. Though measured patterns can compare closely to simulated ones after wrapping up the feeding cable with an absorber, the endfire gain and total efficiency are lower than that of expectation.

In many embodiments, the antenna is an antenna that shares a similar antenna configuration as described above but is fed by a cable with a common mode choke on it. A quarter wavelength sleeve (bazooka) balun can be designed as the choke outside the coaxial feeding. In some embodiments, an antenna with balun has an almost identical measured S₁₁ as one without the balun. In such embodiments, measurements have shown good realized endfire gain, front-to-back (F/B) ratio, and total efficiency as expected. In a number of embodiments, simulated and measured patterns of antennas with such designs on Elevation and Azimuth plane compare closely and demonstrate the endfire radiation of the design. The design philosophies where the theory of CMPA, ground effect, and construction of circuit model are analyzed are discussed below in further detail.

II. Design and Operation

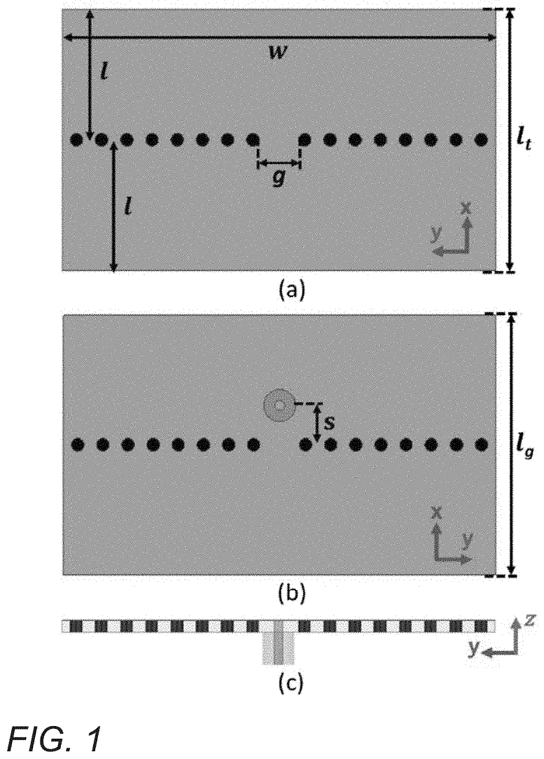

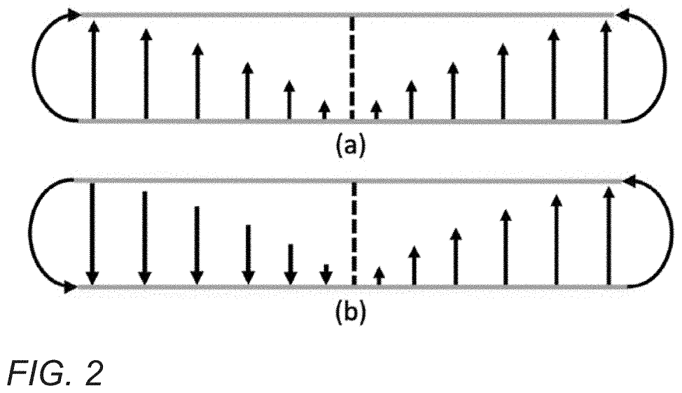

The schematic of an antenna in accordance with various embodiments of the invention is conceptually illustrated in FIG. 1. The size of the antenna is characterized by the width w, top patch length Iₜ=2I, and ground length I_{g}=Iₜ. In the illustrative embodiment, a ground-backed Rogers RO4350B with dielectric constant of 3.66 is chosen to be the substrate so that the length of the antenna is roughly equal to quarter wavelength in free space, Iₜ=I_{g}≈λ₀/4. It has a loss tangent of 0.0031 and height h=1.524 mm. In FIG. 1, the ground and the top patch are configured to have similar sizes, which can reduce or eliminate undesired ground effect while making the design compact. As a model of an actual SMA connector, a coaxial waveguide with inner diameter of 1.27 mm and outer diameter of 4.1 mm is back-fed to the antenna. A hole is thus etched out of the ground (shown by the gray ring in FIG. 1(b)), which contributes for additional phase delay that will be discussed in the following subsection. A row of metal via posts connecting top patch to the ground is put at the center with a gap of 5 mm in the middle as a coupling iris. As a result, the whole cavity (similar to CMPA) can support even and odd mode as two eigen-modes (as shown in FIG. 2). With the constructed coupled modes, the phase of the radiating fields can change with frequency. As shown in FIG. 2, the fringing fields at the edges that radiate indicate that the polarization is perpendicular to the ground (vertical polarization). Although FIG. 1 illustrates a design of an antenna for endfire radiation with vertical polarization, any of a variety of designs can be specified as appropriate to the requirements of specific applications in accordance with various embodiments of the invention.

A. Model of Two-Element Array

The radiation of the antenna is contributed by two equivalent magnetic currents at the radiating slots. In a completely symmetric model, those currents with same magnitude are 180° out-of-phase at even mode and in-phase at odd mode. The pattern of the antenna on E plane is thus dependent on the array factor of two elements:

AF=2 cos[½(k₀d sin θ+Δϕ)] (1)

where k₀ is the propagation constant in free space; d is the separation distance; and Δϕ is the phase difference of the two currents. For simplicity, each of the magnetic currents is assumed to radiate omnidirectionally on E plane.

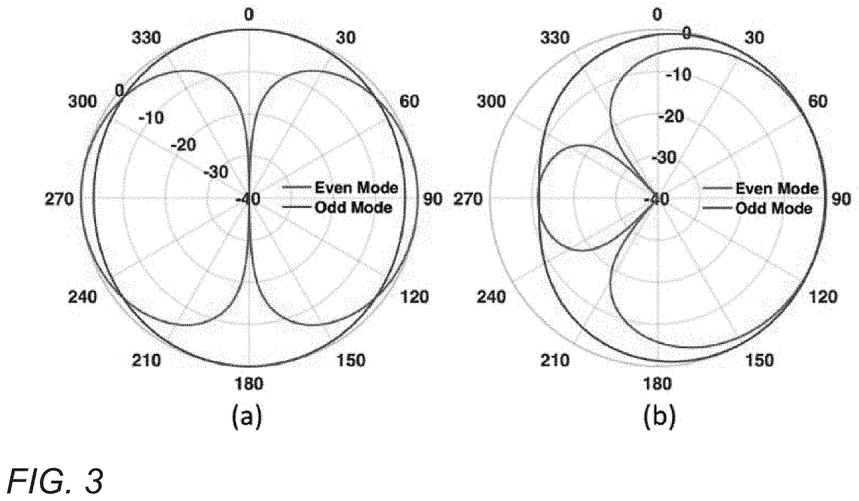

If the separation distance is quarter wavelength, then at even mode Δϕ=180°, the antenna has symmetric backward θ=−90° and forward θ=90° endfire beams; while at odd mode Δϕ=180°, it has symmetric upward θ=0° and downward θ=180° broadside beams (as shown in FIG. 3(a)). Though the even mode offers the endfire radiation, the pattern dramatically changes as the frequency changes from even to odd mode. As an endfire antenna, the design desired should be able to radiate most of the energy towards one endfire direction, either backward or forward, within the whole matching band.

One solution includes bringing in an additional phase delay ϕ₁ to one of the elements. If there is such an additional phase delay, the phase difference at even mode is Δϕ=+180°+ϕ₁ and it is Δϕ=−ϕ₁ at odd mode, due to the boundary condition for the two eigenmodes. With a properly selected ϕ₁, the beam at forward endfire will be larger than one at backward for even mode; while for odd mode, the two beams, which originally point upward and downward, will approach forward endfire. The normalized patterns of AF for even and odd mode with ϕ₁=60°, calculated from Eq. (1), are plotted in FIG. 3(b) to illustrate this idea. With the additional phase delay, the beams for both modes point to forward endfire despite of the slight changing of the patterns. As predicted by Eq. (1), the directivity of odd mode is not maximum at exactly forward endfire, but it is very close to the maximum (as shown in FIG. 3(b)).

There are many methods to introduce an additional phase delay. In some designs, the hole on the ground (such as the one shown in FIG. 1(b)) introduces the additional phase delay to the front side (positive side of x-axis) magnetic current. In the cavity, once the coupled modes are excited, the ground RF current at the front half cavity has to flow around the hole to reach the boundary and thus the total current path is longer than that of the back half cavity. Equivalently, the phase of the field can be delayed. Even or odd mode can be determined by the nature of the coupling, which happens at the center iris, so the hole will delay the phase on the front side but have no effect on the back side. In addition, the hole can cause more phase delay as it is closer to the center, since the RF current there is stronger due to the boundary condition. The location of the hole, on the other hand, can determine the feeding position. If the hole is too close to the center, it might be hard to match the design. Therefore, there is a trade-off between the phase delay and the matching in a sense. However, the matching can be improved in other ways. During the design, the hole for desired phase delay can be located, and then other parameters can be tuned to ensure good matching based on an equivalent circuit model.

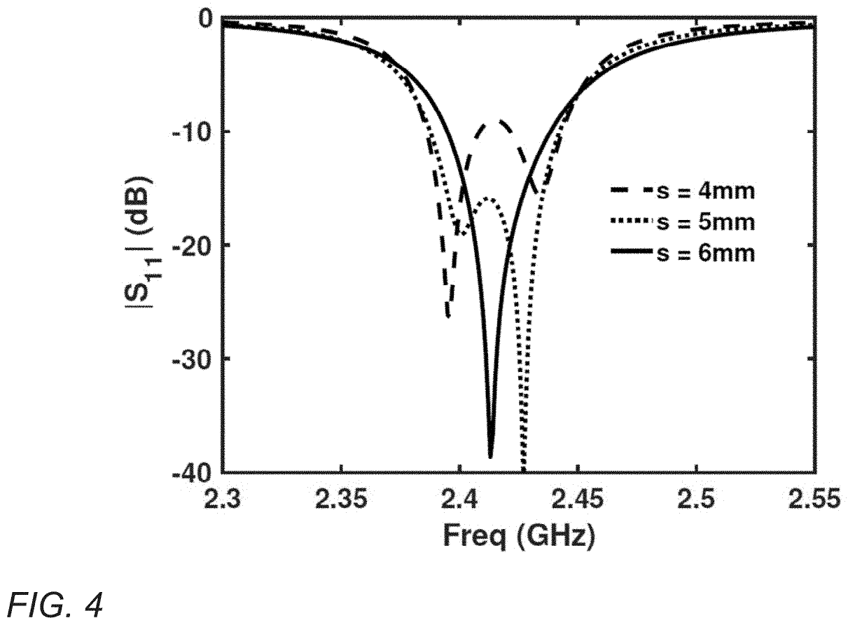

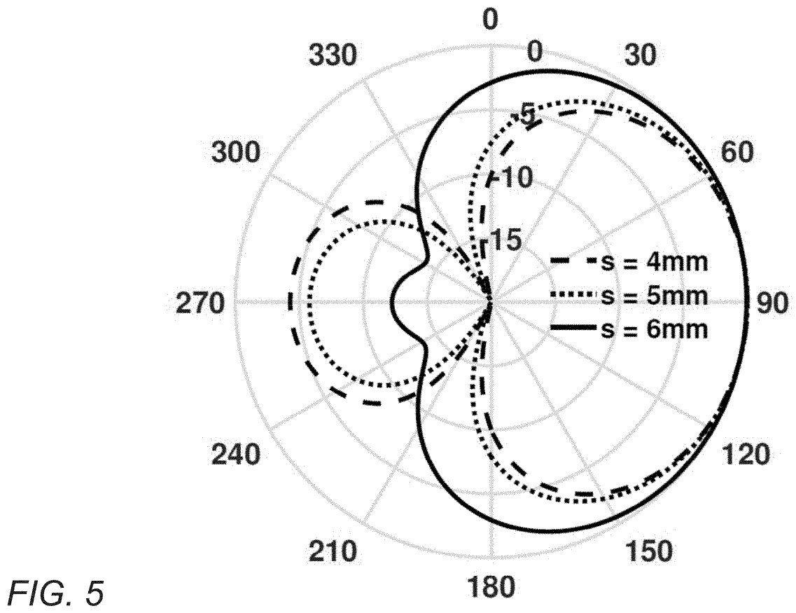

In many embodiments, the feeding can break the symmetry of the excited cavity modes, resulting in the phase shift. FIG. 4 shows simulated frequency responses of the antenna with different excitation locations in accordance with an embodiment of the invention. In FIG. 4, s is the distance between the center via wall and the feeding pin. As shown, the feeding location affects the resonant frequencies of the excited modes. To be more specific, as the feeding moves away from the center, the two frequency poles move closer to each other. This indicates that the location of the excitation has an impact on the coupling, and thus on the excited coupled modes. To further demonstrate the impact on the phase shift, the even-mode pole (low frequency pole) can be tracked. FIG. 5 shows simulated radiation patterns of the antenna with different excitation locations at even-mode pole on xz plane of cut in accordance with an embodiment of the invention. As shown, when the excitation moves away from the center, the x-direction side lobe becomes smaller, indicating more phase shift. In other words, the excitation/feeding causes more phase shift when it is more asymmetrically located (away from center). As such, there is a trade-off between the phase shift and the matching bandwidth in a sense. In some embodiments, the feeding location of the antenna is designed to balance these properties. In the simulations discussed in this section, the ground hole is removed to eliminate its effect when sweeping the feeding location, and the antenna is excited by the embedded feeding pin instead of the outside coaxial waveguide.

B. Finite Ground Plane Effect

The reason why many endfire antenna designs cannot get the beam exactly point at endfire can be attributed to the effect of the finite ground plane. It has been reported how the finite ground plane affect the radiation pattern of a rectangular patch antenna. Patterns calculated by geometrical optics (GO) can be compared with ones by geometrical theory of diffraction (GTD), concluding that the diffraction of the ground edge plays an important role of the broadside pattern of a microstrip patch antenna. The effect of the finite ground is even more important for endfire antennas. GTD can be applied to find the effect. Such effects can also be determined by calculating the patterns with modern full-wave simulators

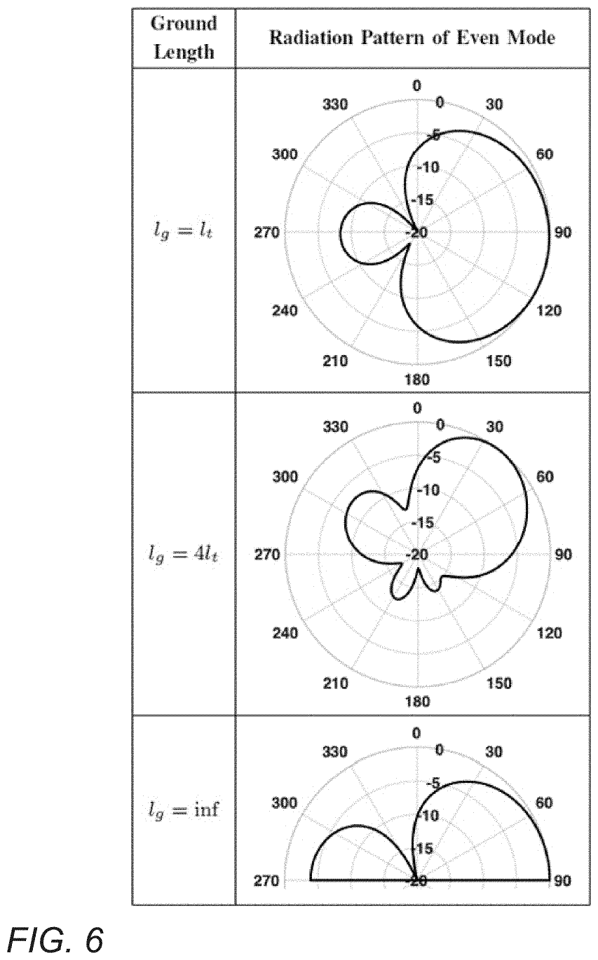

FIG. 6 conceptually illustrates simulated radiation patterns on E-plane of an antenna at even mode with different ground length I_{g}=Iₜ; 4Iₜ; inf (infinite ground) in accordance with an embodiment of the invention. As shown, all three patterns point to the front side because of the additional phase delay as discussed above. If there is no ground effect, the patterns should not change much since the antenna is always operating at even mode. However, the main beam of the finite ground I_{g}=4Iₜ points to θ=38° while the beams for the other two cases are to forward endfire θ=90°. This indicates that a finite ground, larger than the top patch, reflects the beam more to the upside, which makes it hard to achieve endfire radiation. While in the case of I_{g}=Iₜ, the fringing fields directly radiate to the free space without any ground reflection, and thus the beam is exactly at endfire as predicted by Eq. (1).

In practice, mounting the antenna on a much larger ground in terms of wavelength, which behaves like an infinite ground, can solve the problem. Another solution includes truncating the ground to have the same size of the top patch, which offers the endfire radiation as well. In the meantime, the overall size of the antenna itself is reduced, though it comes with a price of lower gain compared to that of infinite ground. The design can be mounted to any ground-like platform, which can result in patterns similar to that of I_{g}=4Iₜ or I_{g}=inf depending on the size of the platform.

C. Circuit Model

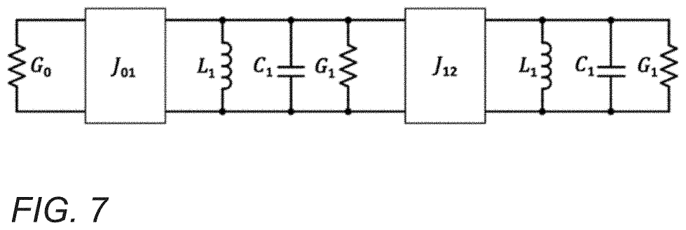

FIG. 7 conceptually illustrates an equivalent circuit model of an antenna in accordance with an embodiment of the invention. Similar to CMPA, the model has only one port as source but no load port. The input energy of the antenna radiates to the free space through the two radiating slots. Due to the symmetry of the design, the same radiation conductance G₁ can be used for both of two half-mode cavities, which is equivalent to the load port in the circuit model. For the same reason, the same shunt LC circuits can be built to represent the resonance of each half-mode cavity.

As the load, G₁ can be theoretically calculated by:

$${G}_{1} = \frac{w}{120 λ} [ 1 - \frac{1}{24} {( \frac{2 π h}{λ} )}^{2} ] \qquad ( 2 )$$

where λ is the resonant wavelength in the cavity. The equation indicates that the load depends on the geometrical size of the design w and h. In other words, there are some freedoms to tune the load to improve matching.

The interstage couplings can affect the matching as well. In the circuit model, the couplings are modeled by the admittance inverters whose values are derived from external quality factor Qₑ and coupling coefficient k by:

$$\begin{matrix}{Q}_{e} = \frac{{b}_{1} {G}_{0}}{{J}_{0 , 1}^{2}} & ( 3 ) \\ k = \frac{{J}_{1 , 2}}{\sqrt{{b}_{1} {b}_{2}}} & ( 4 )\end{matrix}$$

where b₂=b₁=2πfC₁ in the case described above. The external quality factor is related to the feeding, which, to some extent, can be determined by the location of the hole that is fixed to get a desired phase delay as mentioned above. The internal coupling coefficient, however, can be tuned through the coupling gap size g in order to improve the matching. As a conclusion, the circuit model offers a deep understanding of the frequency response, which guides the optimization of designs in accordance with an embodiment of the invention. Simulated and measured results of an antenna sample only and the sample of an antenna fed via balun are demonstrated below in further detail. Although FIG. 7 illustrates a particular circuit model of an antenna, any of a variety of circuit models may be specified as appropriate to the requirements of specific applications in accordance with various embodiments of the invention.

III. Simulations and Measurements

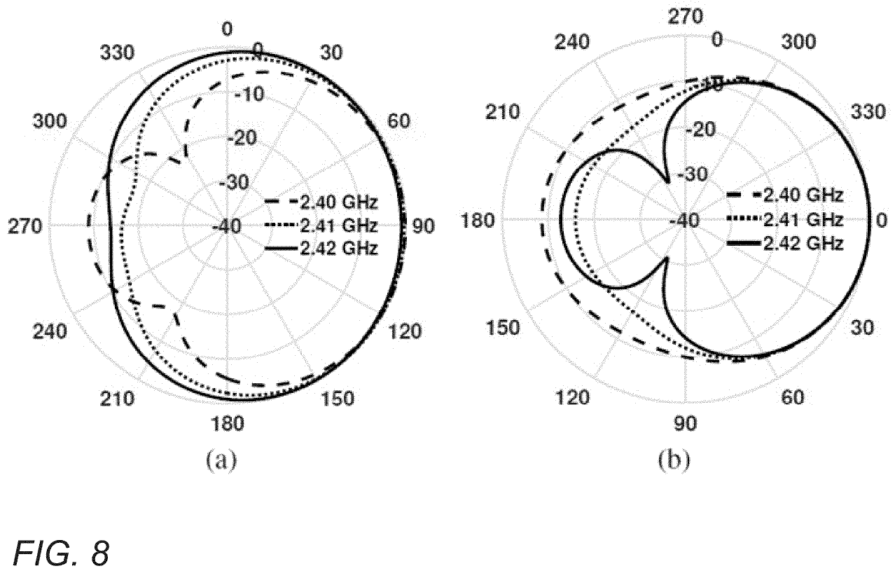

FIG. 8 shows the simulated co-polarized patterns on Elevation plane (E plane, xz plane) and Azimuth plane (xy plane) of an antenna in accordance with an embodiment of the invention. The direction angles are θ in (a) and ϕ in (b). As shown, the patterns are plotted at the frequencies corresponding to the even and odd modes and at the center frequency. At even and odd mode frequencies, the patterns on Elevation plane are actually close to the ones calculated by Eq. (1) as shown in FIG. 3(b). Iₜ also indicates that the undesired ground effect for the design is negligible as expected. The main beams of all frequencies point to forward endfire direction despite of the slight pattern changing. The F/B ratio is around 16 dB at 2.41 GHz, higher than those at the other two frequencies. This can be attributable to the phase difference Δϕ being closer to 90° at the intermediate frequency as indicated by Eq. (1). Barely any perturbation from the common mode current radiation can be observed since only a small length of coaxial cable is included in the simulation. In the illustrative embodiment of FIG. 8, the patterns for the endfire antenna are perturbed by the undesired radiation from the unbalanced current carried on the outside of the coaxial cable. As a result, a common mode choke can be utilized for implementation.

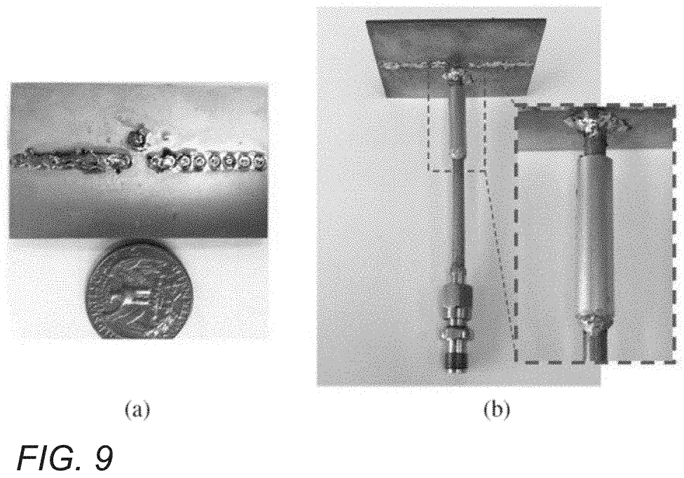

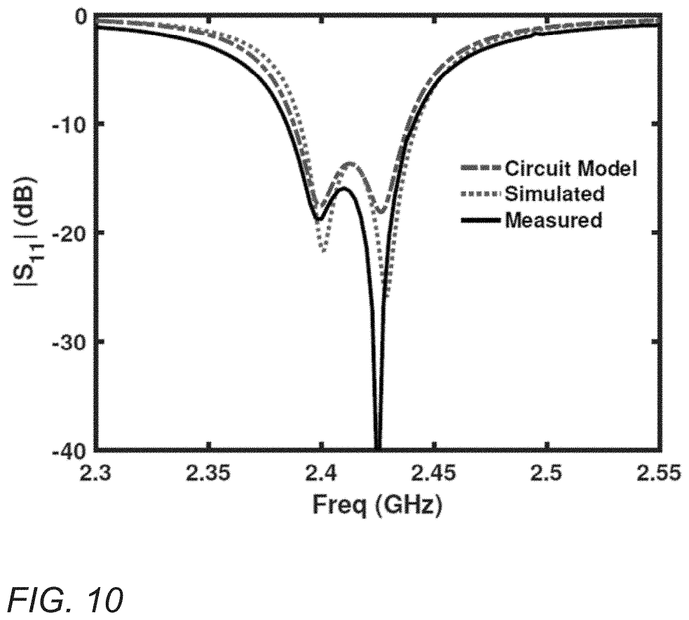

FIG. 9 shows a fabricated sample fed via a quarter-wavelength sleeve (bazooka) balun in accordance with an embodiment of the invention. In the illustrative embodiment, the balun serves as a common mode current choke, which blocks the current carried on the outside of the coaxial cable and thus avoids energy waste and undesired radiations. The reflection coefficient is measured by an Agilent 8510C Vector Network Analyzer. FIG. 10 shows the simulated and measured S₁₁ responses for an antenna with and without a balun in accordance with an embodiment of the invention. As shown, the measured 10-dB bandwidth for the fabricated antenna is 2.5% with center at 2.41 GHz, which is twice the bandwidth of a regular patch antenna with same size and substrate. The slight discrepancy between the measurement and simulation can be attributable to fabrication tolerance. High selective two-pole frequency response is achieved as expected, where the even mode and odd mode are measured at 2.40 GHz and 2.425 GHz, respectively.

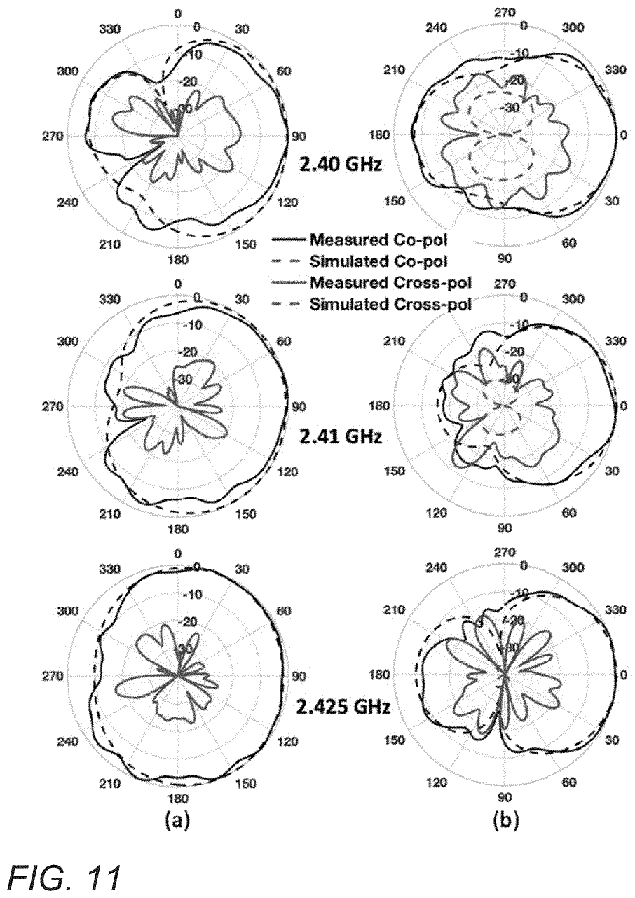

FIG. 11 shows the simulated and measured patterns of an antenna fed via balun in accordance with an embodiment. As shown, the measured co-polarized patterns on both planes match well with the simulated ones, which together show the endfire radiation of the proposed antenna with the beam peak pointing at forward endfire direction. The measured cross-polarized patterns are below −15 dB in general, though they are higher than the simulated ones due to fabrication and measurement tolerances.

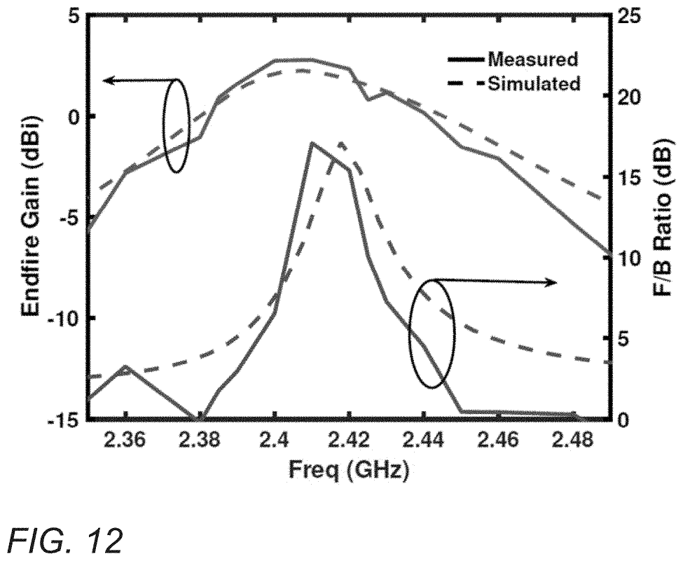

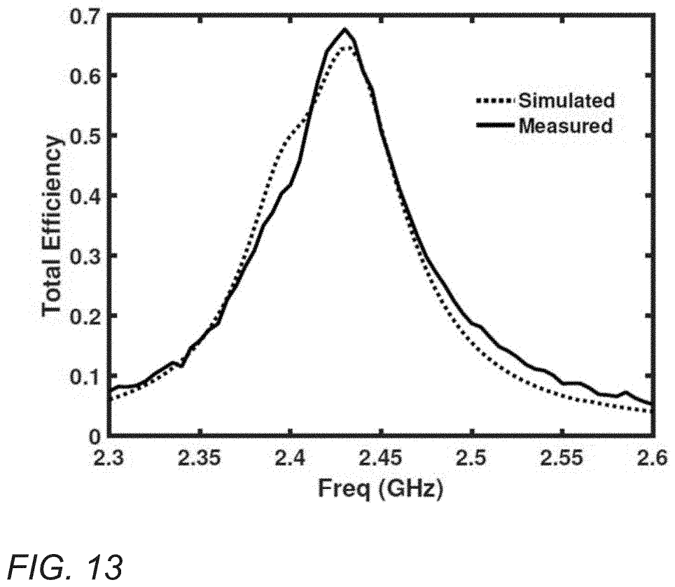

FIG. 12 shows the forward endfire realized gain and F/B ratio of an antenna in accordance with an embodiment of the invention. As shown, the measured and simulated results compare closely. The measured 3-dB bandwidth of realized gain at forward endfire direction is about 2.5% with maximum gain of 2.8 dBi at center frequency of about 2.41 GHz. Considering the compact size of the antenna, the endfire realized gain is respectable. At center frequency, the measured front-to-back (F/B) ratio has a maximum value of 17.1 dB, which indicates good performance of the endfire radiation. The F/B ratio becomes close to 0 dB as the frequency moves away from the center. As the frequency moves away, the phase difference Δϕ gets closer to 0° or 180° where the theoretical patterns are symmetrical forward and backward as shown in FIG. 3(a) based on the analysis of Eq. (1). FIG. 13 shows the measured and simulated total efficiencies of an antenna design in accordance with an embodiment of the invention. As shown, the total efficiencies match well. The maximum total efficiency is about 67.8% measured at 2.43 GHz. Iₜ decays fast as the frequency moves away, indicating the high selectivity of the proposed design. The realized gain and total efficiency take into account the reflection loss due to mismatch.

### DOCTRINE OF EQUIVALENTS

While the above description contains many specific embodiments of the invention, these should not be construed as limitations on the scope of the invention, but rather as an example of one embodiment thereof. Iₜ is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An antenna comprising:
a top patch;
a ground substrate defining a hole;
a feeding cable disposed to mate with the hole;
two coupled radiating resonant cavities having two eigen-modes, wherein the coupled radiating resonant cavities are configured to form a beam; and
wherein the antenna is configured for endfire radiation with vertical polarization.

2. The antenna of claim 1, wherein the feeding cable is wrapped with an absorber.

3. The antenna of claim 2, further comprising a balun configured as a common mode choke on the feeding cable.

4. The antenna of claim 3, wherein the balun is a quarter wavelength sleeve balun as the common mode choke outside the feeding cable.

5. The antenna of claim 1, wherein a length of the antenna is approximately a quarter wavelength in free space to enable endfire patterns.

6. The antenna of claim 1, wherein the feeding cable provides a phase shift to the edge fields at one side to make the beam of the antenna pointing to the forward endfire at both even and odd mode.

7. The antenna of claim 1, wherein the ground substrate is the same size as a top patch to avoid diffraction of the ground edges.

8. The antenna of claim 1, wherein the ground substrate has a dielectric constant of 3.66 so that the length of the antenna is approximately equal to a quarter wavelength in free space.

9. The antenna of claim 1, further comprising a plurality of metal vias arranged in a line connecting the top patch to the ground substrate and are positioned at the center.

10. The antenna of claim 9, further comprising a gap, wherein the plurality of metal vias are placed in a line from one side to the other side of the antenna and the gap is an enlarged spacing omitting vias in the center of the line.

11. The antenna of claim 10, where the gap is about 5 millimeters.

12. The antenna of claim 9, wherein the metal vias have a spacing of about 3.2 millimeters.

13. The antenna of claim 9, wherein the metal vias have a diameter of about 1.6 millimeters.

14. The antenna of claim 1, wherein the antenna works in coupled modes.

15. The antenna of claim 14, wherein the coupling is either even mode or odd mode.

16. The antenna of claim 1, wherein the ground substrate comprises of a dielectric material.

17. The antenna of claim 1, wherein the top patch comprises of a conductive material.

18. The antenna of claim 1, wherein the feeding cable is back-fed to the antenna.
